(19) United States
(12) Patent Application Publication
(10) Pub. No.: US 2006/0196405 A1
(43) Pub. Date: Sep. 7, 2006

(54) Sport horn and method making and using the horn

(76) Inventor: Zev Cohen, Bethesda, MD (US)

Correspondence Address: GREENBLUM & BERNSTEIN, P.L.C., 1950 ROLAND CLARKE PLACE, RESTON, VA, 20191, US

(21) Appl. No.: 11/067,888

(22) Filed: Mar. 1, 2005

(51) Int. Cl. G10K 9/04

(52) U.S. Cl. 116/142 FP

(57) ABSTRACT

Sound making device includes a body having a front end, a rear end, an outer side wall arranged between the front and rear ends, and an inner side wall arranged within the outer side wall. At least one through opening arranged to allow air to enter the body. A membrane material is arranged within the body. A first chamber is defined by the outer side wall, the inner side wall and a portion of the membrane material. A second chamber is defined by the inner side wall and another portion of the membrane material. The sound making device produces a sound when a user blows air through the at least one opening and when the air moves from the first chamber to the second chamber and then out of the front end of the body. This Abstract is not intended to define the invention disclosed in the specification, nor intended to limit the scope of the invention in any way.

### BACKGROUND OF THE INVENTION

1. Field of the Invention

The invention relates to a sound and/or noise making device which produces a sound when a user blows into the device. The invention also relates to a horn which can be used at, e.g., sporting events, among other places. The invention also relates to a portable horn device which produces a very loud sound when a user blows into the horn. The invention also relates to a method of making the horn and to a method of using the horn to produce a loud sound and/or noise.

2. Discussion of Background Information

Horns, whistles, and noise makers are known, as are the use of such devices at sporting events. However, such devices are either insufficiently loud, and/or require significant and potentially uncomfortable amounts of breath, and/or are relatively expensive. Many noise making devices even require a power source or a pressurized air source.

### SUMMARY OF THE INVENTION

The instant invention provides a portable inexpensive noising making device which can be operated in a simple manner, is simple in design and construction, is easy to handle and carry, and which produces a very loud sound and/or noise without requiring large and potentially uncomfortable amounts of breath.

According to one illustrative aspect of the invention, a sound making device includes a body having a front end, a rear end, an outer side wall arranged between the front and rear ends, and an inner side wall arranged within the outer side wall. At least one through opening is arranged at least one of on the outer side wall and to allow air to enter into the body. A membrane material is arranged within the body. A first chamber is defined by the outer side wall, the inner side wall and a portion of the membrane material. A second chamber is defined by the inner side wall and another portion of the membrane material. The sound making device produces a sound when a user blows air into the at least one opening and the air moves from the first chamber to the second chamber and then out of the front end of the body.

The first chamber may be arranged to surround at least a part of the second chamber. A rear end of the inner side wall may extend rearwardly beyond a rear end of the outer side wall. The first chamber with the exception of the at least one opening may be an enclosed chamber and the second chamber may be open to the outside atmosphere via the open front end of the body.

The outer side wall may be at least one of a tapered wall and a conical wall. The front end of the body may comprise a smaller diameter than a diameter of the rear end. The membrane material may comprise a generally planar portion and a rim portion that is fixed within the body. The device may further comprise a rear cap arranged on the rear end of the body. An inner surface of the rear cap may frictionally engage the rim portion. The membrane material may be tensioned, stretched, and/or prestressed.

The device may further comprise a rear cap, having a plurality of openings, arranged on the rear end of the body.

The device may further comprise a rear cap, having a plurality of through openings, removably arranged on the rear end of the body. An inner surface of the rear cap frictionally engages a rim portion of the membrane material.

The device may further comprise at least one of a flexible continuous tension member coupled to the body, a chain coupled to the body, and a bead chain coupled to the body.

The body may comprise at least one of a rear cap arranged on the rear end and a front section arranged on the front end. The body may comprise a rear cap, a front section, and a main body arranged between the rear cap and the front section.

The body may comprise a rear cap member which includes a plurality of through openings, a front section member, and a main body member. At least the front section member is removably connected to the main body member.

The body may comprise a rear cap member which includes a plurality of through openings, a front section member, and a main body member. Each of the rear cap member and the front section member are removably connected to the main body member.

The invention also provides for a method of making sound with the sound making device described above. The method comprises placing the body adjacent a user's lips, blowing air through the at least one opening, and allowing the air to exit the front end.

The invention also provides for a method of making the sound making device described above. The method comprises forming a main body portion of the body, arranging the membrane material within the body so that a rim portion of the membrane material is fixed within the body and so that a main portion of the membrane material is stretched, and connecting a rear cap to the main body portion.

The invention additionally provides for a sound making device comprising a main body having a front end, a rear end, an outer side wall arranged between the front and rear ends, and an inner side wall arranged within the outer side wall. At least one through opening is arranged on the outer side wall. A membrane member is arranged within the body and comprises a rim portion and a main portion. The rim portion of the membrane member is fixed and the main portion of the membrane member is at least one of stretched, subjected to tension, and assumes a generally planar configuration. A rear cap is coupled to the rear end of the main body and comprises a plurality of through openings. A first chamber is defined by the outer side wall, the inner side wall and an outer portion of the main portion of the membrane member. A second chamber is defined by the inner side wall and an inner portion of the main portion of the membrane member. The sound making device produces a sound when a user blows air into the at least one opening and the air moves from the first chamber to the second chamber and then out of the front end.

The outer side wall may be at least one of a tapered wall and a conical wall. The front end of the main body may comprise a smaller diameter than a diameter of the rear end. An inner surface of a rim of the rear cap may frictionally engage the rim portion of the membrane member. The device may further comprise a front section removably connected to the front end of the main body.

The invention additionally also provides for a method of making sound with the sound making device described above. The method comprises placing the main body adjacent a user's lips, blowing air through the at least one opening, and allowing the air to exit the front end.

The invention also provides for a method of making the sound making device described above. The method comprises connecting the membrane member to the main body and connecting the rear cap to the rear end of the main body so that the rim portion of the membrane member is trapped between an outer surface of the main body and an inner surface of the rear cap.

The invention also provides for an air horn comprising a main body having a front end, a rear end, an outer generally conical side wall arranged between the front and rear ends, and an inner side wall arranged within the outer generally conical side wall. At least one through opening is arranged on the outer generally conical side wall. A generally circular membrane member is arranged within the air horn and comprises a rim portion and a main portion. The rim portion of the generally circular membrane member is fixed and the main portion is at least one of stretched, subjected to tension, and assumes a generally planar configuration. A rear cap is coupled to the rear end of the main body and comprises a plurality of through openings. A front section comprises an open front end and a rear end coupled to the front end of the main body. A first chamber is defined by the generally conical outer side wall, the inner side wall and an outer portion of the main portion of the membrane member. A second chamber is defined by the inner side wall and an inner portion of the main portion of the membrane member. The horn produces a sound when a user blows air into the at least one opening and the air moves from the first chamber to the second chamber and then out of the open front end of the front section.

The invention also provides for a breath operated horn comprising a main body comprising a front end, a rear end, an outer generally conical side wall arranged between the front and rear ends, and an inner side wall arranged within the outer generally conical side wall. At least one through opening is at least one of arranged on the outer generally conical side wall and arranged to allow breath to enter the horn. A generally circular membrane member is arranged within the air horn and comprises a rim portion and a main portion. The rim portion of the generally circular membrane member is fixed and the main portion is at least one of stretched, subjected to tension, and assumes a generally planar configuration. A rear cap is coupled to the rear end of the main body and comprises a plurality of through openings. A front section comprises a rear end coupled to the front end of the main body and an open front end. A first chamber is defined by the generally conical outer side wall, the inner side wall and an outer portion of the main portion of the membrane member. A second chamber is defined by the inner side wall and an inner portion of the main portion of the membrane member. The horn produces a sound when a user blows air through the at least one opening and the air moves from the first chamber to the second chamber, when the air vibrates at least a portion of the membrane member, and then moves out of the open front end of the front section.

The air horn may produce a loud sound using only a user's breath and/or air that is blown into the air horn from a user's lungs and lips. The air horn may at least one of weigh less than approximately 1 pound, be less than approximately 12″ in length, be capable of being held with one hand, and be no greater than approximately 3″ in diameter.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a side view of one embodiment of the horn. The horn can include a bead chain for allowing a user to more easily carry the horn;

FIG. 2 shows a top view of the horn of FIG. 1 with the bead chain removed;

FIG. 3 shows a bottom view of the horn of FIG. 1 with the bead chain removed;

FIG. 4 shows a cross-section view of section A-A of FIG. 5, but with the rear cap removed;

FIG. 5 shows a side view of the horn of FIG. 1, but with the bead chain removed;

FIG. 6 shows a cross-section view of section B-B of FIG. 6;

FIG. 7 shows a bottom side view of the rear cap used in the horn of FIG. 1;

FIG. 8 shows a bottom side view of the membrane cap used in the horn of FIG. 1;

FIG. 9 shows a bottom side view of the main body used in the horn of FIG. 1;

FIG. 10 shows a bottom side view of the front section used in the horn of FIG. 1;

FIG. 111 shows an enlarged cross-section view of the front section of FIG. 10;

FIG. 12 shows an enlarged cross-section view of the main body of FIG. 9;

FIG. 13 shows a rear view of the membrane cap of FIG. 8;

FIG. 14 shows a cross-section view of the membrane cap of FIG. 13;

FIG. 15 shows an enlarged cross-section view of FIG. 14;

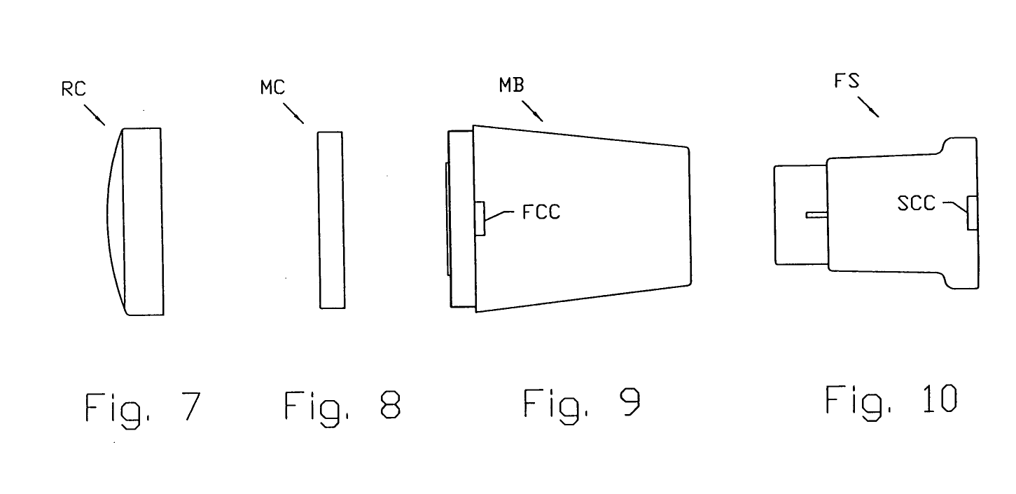

FIG. 16 shows a front inside view of the rear cap of FIG. 7;

FIG. 17 shows a cross-section view of FIG. 16;

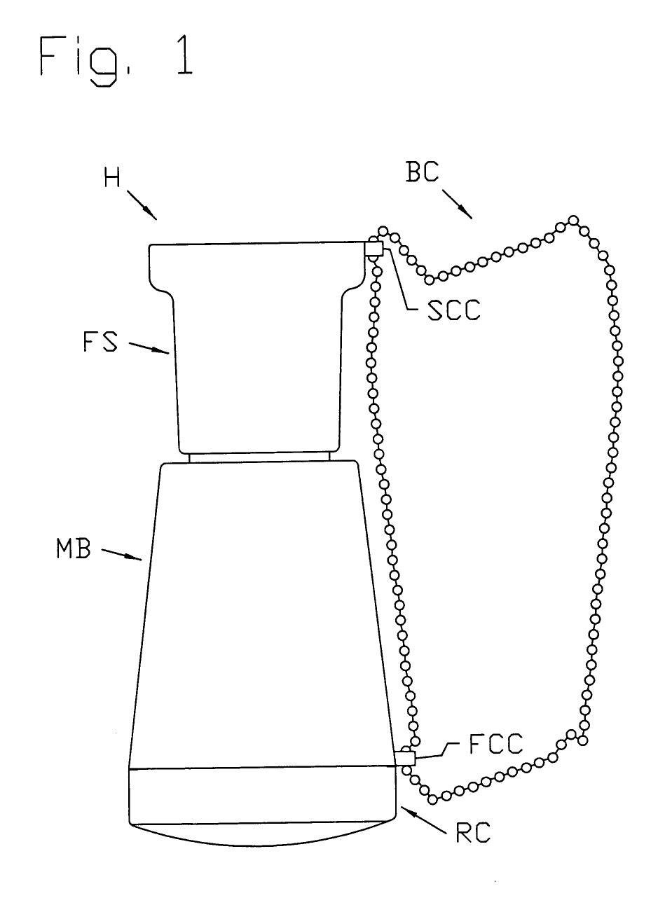

FIG. 18 shows a cross-section view of the horn of FIG. 1 illustrating air flow through the horn during use of the horn to produce sound/noise. The bead chain has been removed; and

FIG. 19 shows an enlarged partial view of FIG. 18 illustrating how the membrane cap is arranged within the horn.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

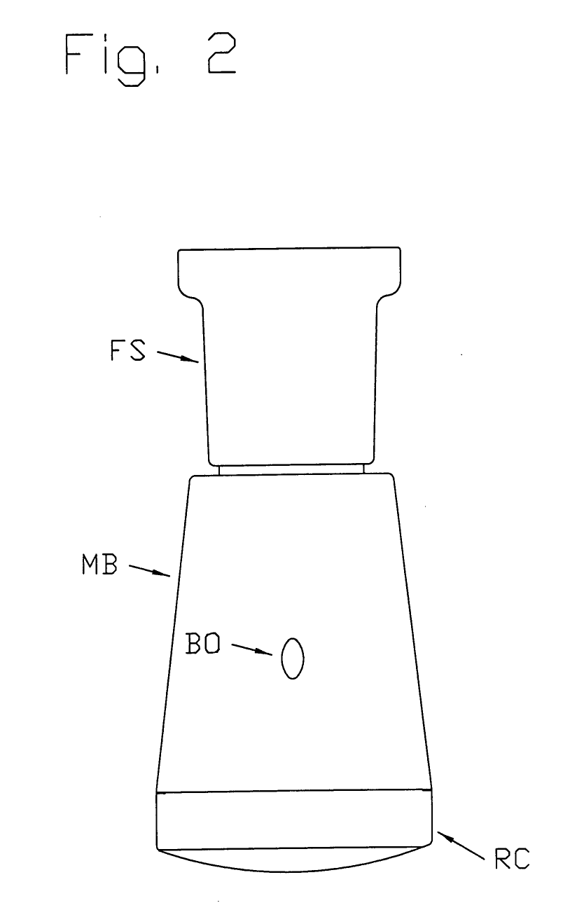

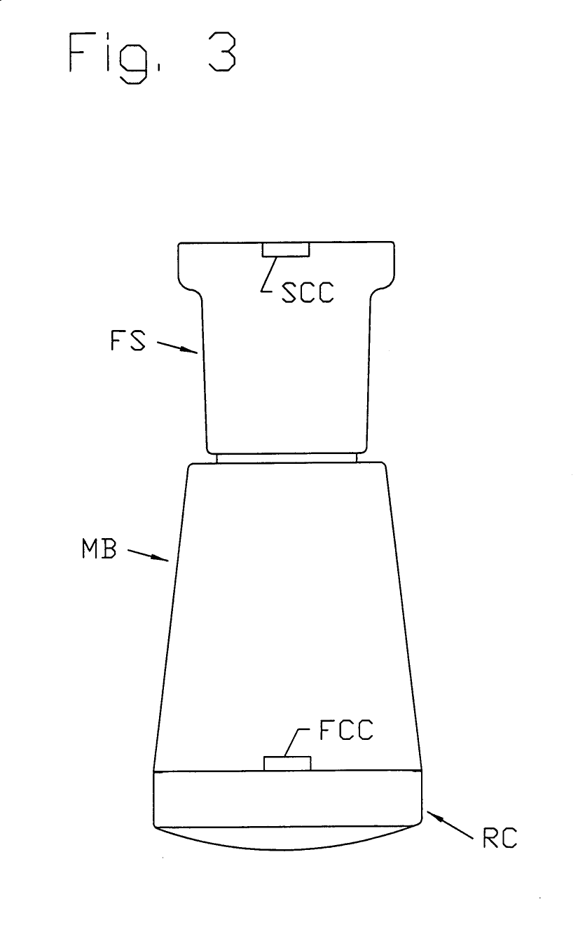

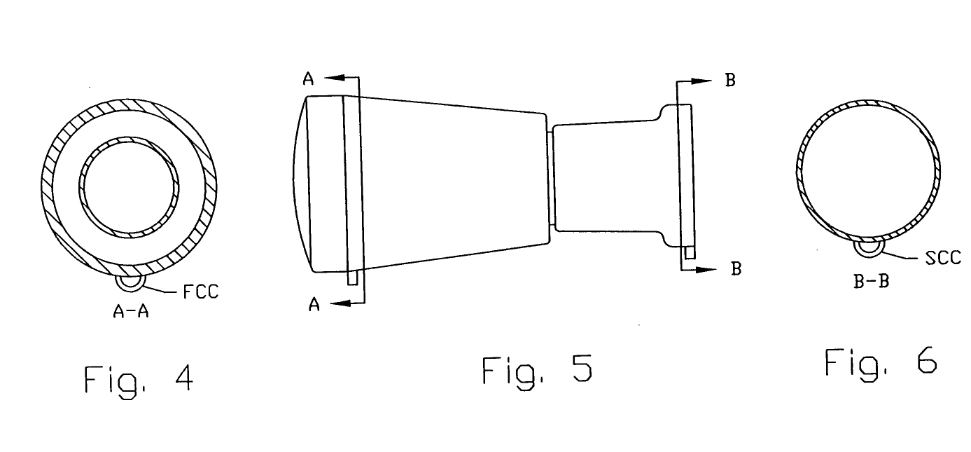

FIGS. 1-19 show one non-limiting embodiment of the noise making device in the form of a sport horn H. In order to allow the user to more easily carry and store the horn H, a bead chain BC is connected to the horn H at one or more locations or connections. Although the horn H is shown using a bead chain BC, the invention contemplates using other flexible tension devices such as a string, other types of chain, etc. By way of non-limiting example, one of these locations/connections is at location FCC and is arranged on a main body MB. Another of these locations/connections is at location SCC and is arranged on a front section FS. As can be seen in FIGS. 4 and 6, the connections FCC and SCC can have the form of partial loops which are integrally formed with main body MB and front section FS respectively. Of course, these connections can have any desired form and are not limited to partial loops. Moreover, these connections can be located at any desired location on the horn H and can even be dispensed with if the horn H is to be used and/or sold without using a bead chain BC or other such supporting device. The horn H also includes a generally circular rear cover or cap RC. In order to allow a user to blow air into the horn H, an opening BO (see FIG. 2) is arranged on the main body MB, and more specifically an outer side wall MB1 (see FIG. 18) of the main body MB.

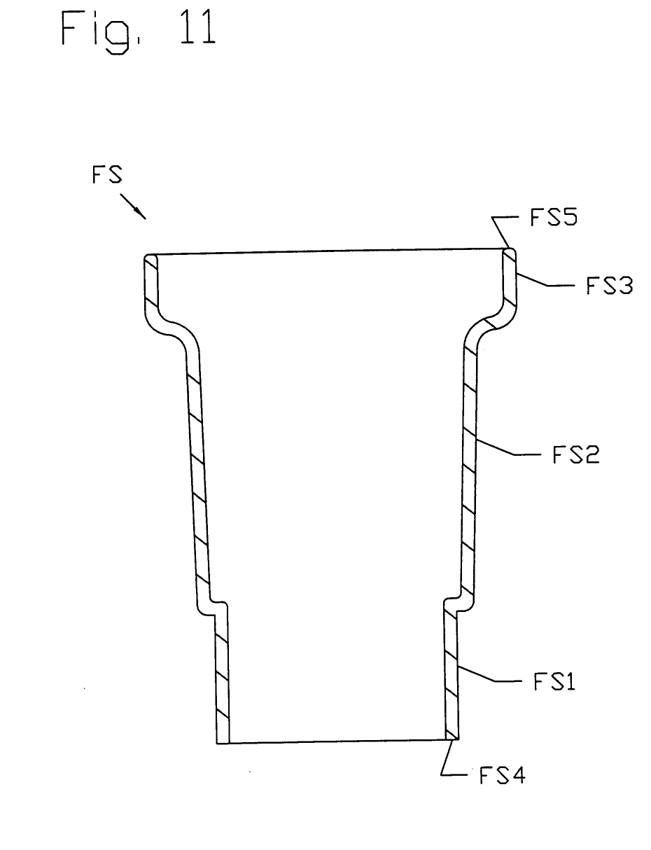

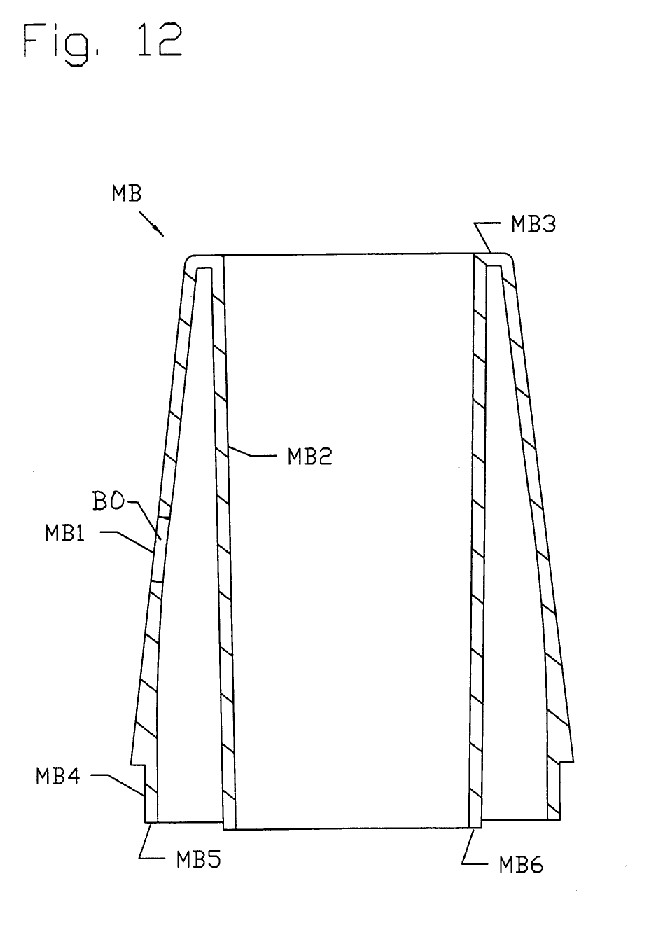

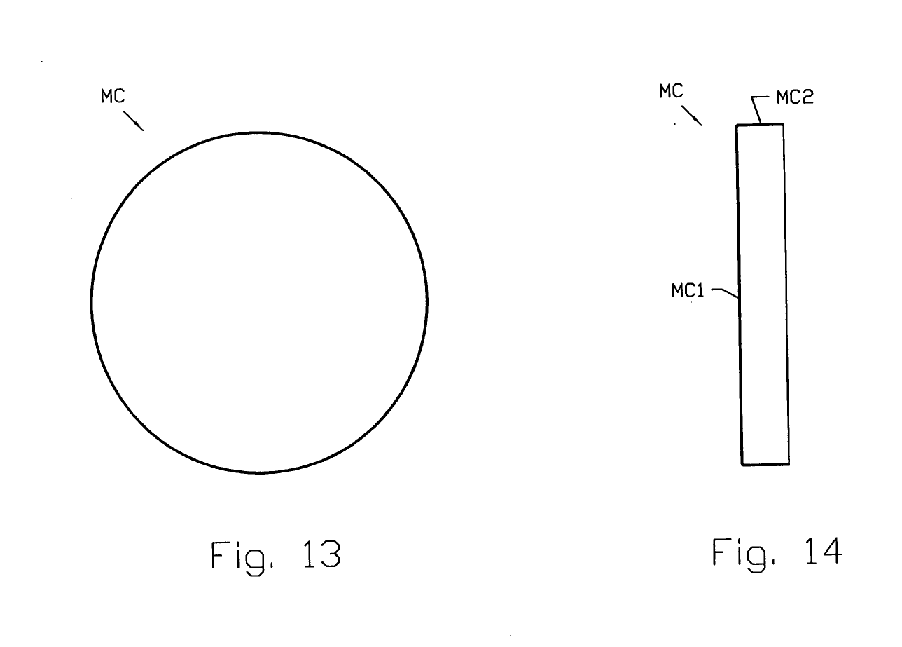

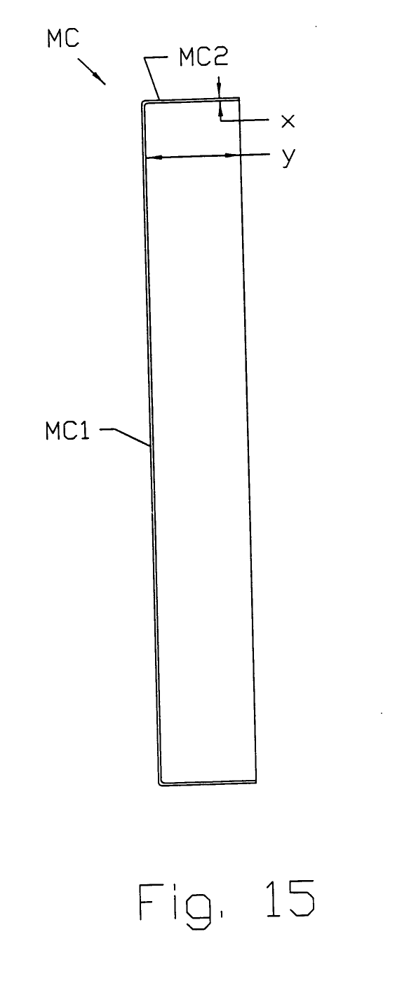

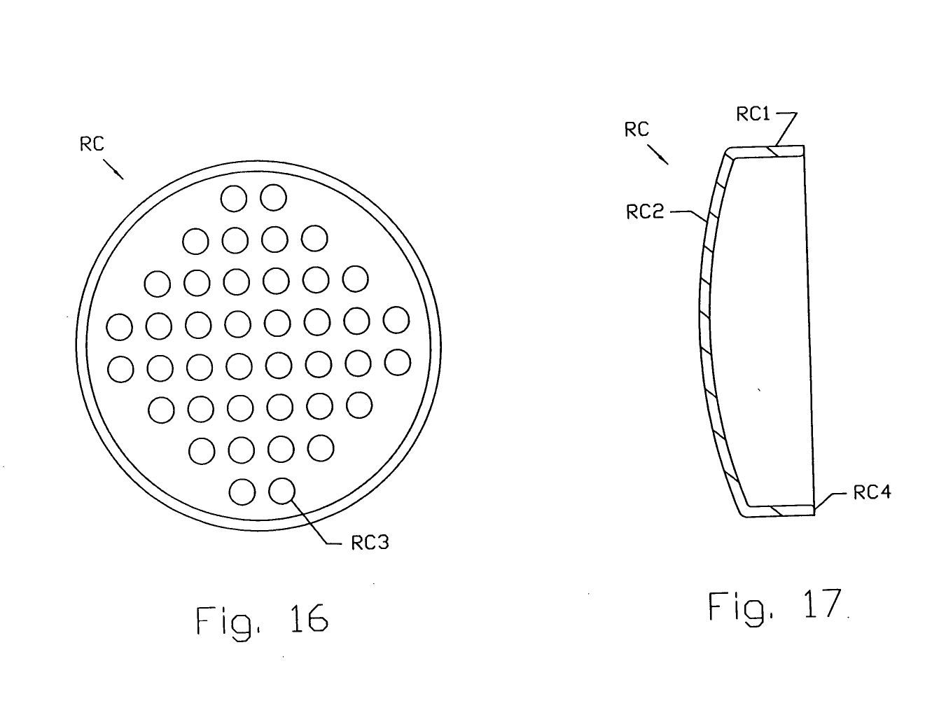

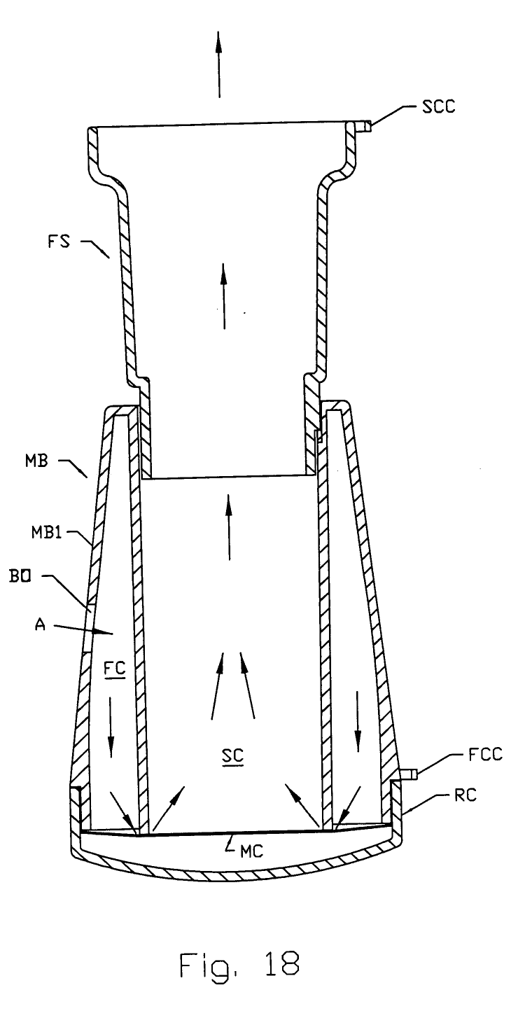

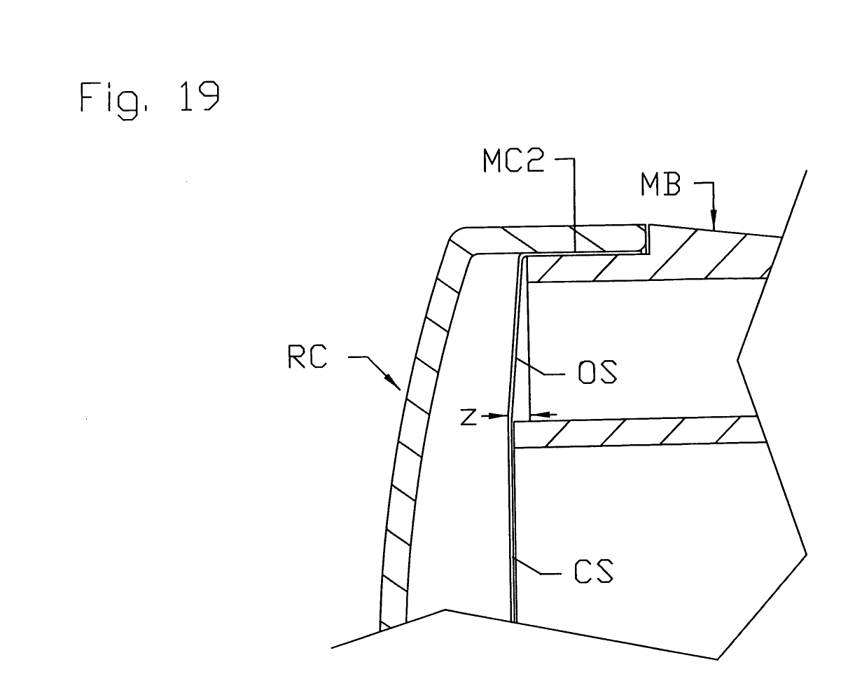

By way of non-limiting example, an overall axial length of the horn H can be approximately 6.5″. With reference to FIGS. 7-10, it can be seen that the horn H includes 4 one-piece parts. One of these parts is a generally circular front section FS. Although the front section FS is not required for the horn H to produce sound, another types/configurations of front sections can be utilized, it is preferable to use the front section FS on the horn H in order to control and/or attenuate the sound level. In this regard, the front section FS can be either fixed to the main body MB or, as is preferred, can be removably connected to a front end of the main body MB. Although other materials are possible, the front section FS is preferably made of a synthetic resin material such as, e.g., ABS plastic and can be made by e.g., injection molding. To ensure that the front section FS is properly aligned with the main body MB, so that, e.g., the connections FCC and SCC are aligned with one another, the front section FS can include, by way of non-limiting example, a projection OP (see FIG. 10) which engages within a recess (see FIG. 18) of the main body MB. Of course, the projection and recess can be replaced with any desired alignment mechanisms without leaving the scope of the invention. Another of these parts is a rear cap RC. The rear cap RC can be either fixed to the main body MB or, as is preferred, can be removably connected to a rear end of the main body MB. Although other materials are possible, the rear cap RC, like the front section FS and the main body MB, is preferably made of a synthetic resin material such as, e.g., ABS plastic and can be made by e.g., injection molding. The rear cap RC need not be properly aligned with the main body MB. On the other hand, if desired, the rear cap RC can include, by way of non-limiting example, a projection which engages within another recess of the main body MB. Of course, the projection and recess can be replaced with any desired alignment mechanisms without leaving the scope of the invention. Another of these parts is a membrane cap MC. The membrane cap MC can be either fixed to the main body MB or, as is preferred, can be removably connected to a rear end of the main body MB. Although other materials are possible, the membrane cap MC is preferably made of a synthetic resin material such as, e.g., HDPE plastic film. The membrane cap MC need not be properly aligned with the main body MB. It can even be made by bending and/or folding a peripheral edge portion of a circular section of material over the ends MB5 and MB4 of the main body MB.

With reference to FIG. 1, it can be seen that the front section FS has a stepped configuration with an enlarged front generally cylindrical portion FS3 which terminates in a front edge FS5 and a smaller diameter rear generally cylindrical portion FS1 which terminates in a rear edge FS4. As shown in FIG. 18, the section FS1 is sized to slidably engage within a main opening in the main body MB and is designed to retain its position by frictional engagement with the main body MB. By way of non-limiting example, the front section FS can have an overall axial length between edges FS4 and FS5 of approximately 3.15″. The diameter of section FS1 can be approximately 1.55″ and the diameter of section FS3 can be approximately 2.25″. Section FS2 can be tapered slightly so that its diameter increases gradually from section FS1 to section FS3. It is also possible to provide section FS1 with a slight taper so that the front section FS can become wedged into the main body MB and thereby ensure that it is more securely connected to the main body MB. By way of non-limiting example, the wall thickness of the front section FS can be generally uniform and can be approximately 2 mm. Of course, the front section FS need not have a stepped configuration and can have, e.g., a generally conical configuration and/or can even resemble the shape of a horn.

With reference to FIG. 12, it can be seen that the main body MB has an enlarged open rear end which includes a generally cylindrical portion MB4 which terminates in a rear edge MB5 and a smaller diameter closed front end which terminates with a front connecting wall MB3. As shown in FIG. 18, the section MB4 is sized to slidably engage within a rim portion RC1 of the rear cap RC. In this way, the rear cap RC is designed to be retained on the main body MB via frictional engagement with the main body MB, and more specifically via frictional engagement with the rim portion MC2 of the membrane member MC which is itself in frictional engagement with the cylindrical wall MB4. By way of non-limiting example, the main body MB can have an overall axial length between wall MB3 and edge MB6 of approximately 3.80″. The diameter of section MB4 can be approximately 2.55″ and an outer diameter of wall MB3 can be approximately 2″. Outer wall MB1 can be tapered and/or conical so that its diameter increases from wall MB3 up to the start of section MB4. Wall section MB2 is coaxial, i.e., both share the same center axis, with the outer wall MB1 and defines a through opening and is slightly tapered so that in the area of the wall MB3, the inside diameter of wall MB2 is approximately 1.58″ and the inside diameter of wall MB2 in the area of edge MB6 is approximately 1.45″. The edge MB6 also extends axially rearwardly beyond edge MB5 by approximately 1/16″ in order to ensure that the membrane member MC is stretched and/or tensioned when the rear cap RC is installed on the main body MB (see FIG. 19). By way of non-limiting example, the wall thickness of the walls MB1, MB2, MB3, and MB4 of the main body MB, with the exception of the thick area adjacent the section MB4, can be generally uniform and can be approximately 2 mm.

With reference to FIGS. 13-15, it can be seen that the membrane member or cap MC has a main section MC1 which is generally circular or disk-shaped and a rim portion MC2. As shown in FIGS. 18 and 19, when the membrane member MC is installed on the horn H, the rim MC2 is trapped and/or squeezed between the rim portion RC1 of the rear cap RC and the outer cylindrical surface of the wall MB4. In this way, both the rear cap RC and the membrane member MC are retained on the main body MB via frictional engagement. Installation of the rear cap RC onto the main body MB, after the membrane member MC is installed onto the main body MB, also causes the membrane member MC to experience a radial tensioning or stretching so that a central section CS of the membrane member MC assumes a generally planar configuration (see FIGS. 18 and 19) by virtue of being stretched over the generally circular edge MB6. The outer section OS of the membrane member MC becomes partially tapered or conical by virtue of the tensioning and/or the stretching of the membrane member MC. By way of non-limiting example, the membrane member MC can have an overall axial length of approximately 0.30″. The outer diameter of rim section MC2 can be approximately 2.55″. Also by way of example, the distance “y” can be approximately 0.296″ and the thickness of the membrane member “x” can be between approximately 0.003″ and approximately 0.010″. Because of the relatively thin wall thickness “x” of the membrane member MC, the rim section MC2 can easily be formed by merely folding over the peripheral edge area of a circular-shaped membrane material. By way of non-limiting example, the dimension “z” shown in FIG. 19 can be approximately 0.07″.

With reference to FIGS. 16 and 17, it can be seen that the rear cap RC has a generally cylindrical section RC1 and has an opened front end defined by circular edge RC4 and a closed rear end defined by outwardly curved wall RC2. As shown in FIG. 16, the wall RC2 includes a plurality of through openings RC3. The particular size, shape, and arrangement of these openings RC3 can be varied and the invention is not limited to any particular size, shape, and/or arrangement. Moreover, the wall RC2 can be made planar and/or inwardly curved provided it does not interfere with the membrane member MC, which must be free to vibrate and/or flex somewhat when air is introduced into the horn H. By way of non-limiting example, the rim RC1 can have an outer diameter of approximately 2.70″. The overall axial length of the rear cap RC can be approximately 0.80″. It is also possible to provide rim section RC1 with a slight taper so that it can become wedged into the main body MB and thereby ensure that it is more securely connected to the main body MB. By way of non-limiting example, the wall thickness of the rear cap RC can be generally uniform and can be approximately 2 mm and the openings can be approximately 0.18″ in diameter.

The operation of the horn H will now be described with reference to FIG. 18. FIG. 18 shows the fully assembled horn H after the rear end of the front section FC has been slid into the front end of the main body MB and after the membrane member MC has been trapped and stretched onto the rear end of the main body MB by the rear cap RC. In the assembled state shown in FIG. 18, a user grips the horn H and places the user's lips against the outer wall MB1 and over the opening BO. As can be seen in FIG. 2, by way of non-limiting example, the opening BO can have a generally oval, e.g., football shape, whose width can be approximately 0.2″ and whose length can be approximately 0.5″. Alternatively, the opening BO can have any other desired shape. The user can blow air A into the horn H. The air A will then move in the general direction indicated by the arrows. It is believed that due to the air A flowing within the horn H, contacting the membrane member MC and passing from the outer enclosed first chamber FC, which is defined by walls MB1, MB2, MB3 and outer section OS of the membrane member MC, the membrane member MC is caused to vibrate as the air A passes to the inner open second chamber SC, which is defined by inner wall MB2 and the central section CS of the membrane member MC. The air A then flows out through the front end of the front section FS of the horn H thereby producing a very loud sound relative to the amount of breath or air A input into the horn H.

The horn H can be made of any desired material, although it is preferred that the main body MB, the front section FS and the rear cap RC be made of synthetic resin. However, it is preferred that the horn H be made of synthetic resin materials whose colors match a particular school, team, location, etc,. In this regard, the front section FS can be made of a synthetic resin which has a different color than the main body MB. The rear cap RC can also have the same color as the front section FS or alternatively, it can be a different color than both the main body MB and the front section FS. The horn H can even be made of transparent and/or translucent synthetic resin materials so that a user will be able to see the inner workings and/or design of the horn H. Of course, the invention is not limited to any particular material and/or color combination.

All the parts of the horn, with the exception of the membrane member MC (which can be made of paper, rubber, or synthetic resin sheet materials such as, e.g., Mylar, PET, HDPE, PVC, LDPE, Polypropylene, PVDC, Nylon, Polyester, COEX, Polyethylene, and/or films or membranes made by layering one or more of these materials and with or without reinforcing layers, etc.,), may be made from plastic materials such as, e.g., ABS, Nylon, PMMA, PS, PVC, PP, PE, Polycarbonate, etc., and can be formed using conventional injection molding techniques or other known manufacturing methods. However, when practical, other materials and manufacturing processes may also be utilized.

By way of non-limiting example, the invention can be made with the proportional configuration shown in the drawings. Although the drawings are not to scale, the relative size, shape, and dimensions of the features shown in the drawings can be relied upon to provide support for any feature recited in the claims relating to size, shape, and configuration. Moreover, lines which appear in the drawings to be parallel are intended to represent lines which are generally parallel to each other. Lines which appear in the drawings to be perpendicular are intended to represent lines which are generally perpendicular to each other. Lines which appear in the drawings to angled and not be parallel are intended to represent lines which are generally non-parallel to each other.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A sound making device comprising:
a body having a front end, a rear end, an outer side wall arranged between the front and rear ends, and an inner side wall arranged within the outer side wall;
at least one through opening for allowing air to enter into the body;
a membrane material at least one of arranged within the body and coupled to a portion of the body;
a first chamber being defined by the outer side wall, the inner side wall and a portion of the membrane material; and
a second chamber being defined by the inner side wall and another portion of the membrane material,
wherein the sound making device produces a sound when a user blows air through the at least one opening and the air moves from the first chamber to the second chamber and then out of the front end of the body.

2. The device of claim 1, at least one of:
the outer side wall being at least one of a tapered wall and a conical wall; and
the front end of the body comprising a smaller diameter than a diameter of the rear end.

3. The device of claim 1, wherein the membrane material comprises a generally planar portion and a rim portion that is fixed within the body and wherein the at least one through opening is arranged on the outer side wall.

4. The device of claim 3, further comprising a rear cap arranged on the rear end of the body, wherein an inner surface of the rear cap frictionally engages the rim portion.

5. The device of claim 1, further comprising a rear cap having a plurality of openings and being arranged on the rear end of the body.

6. The device of claim 1, further comprising a rear cap having a plurality of through openings and being removably arranged on the rear end of the body, wherein an inner surface of the rear cap frictionally engages a rim portion of the membrane material.

7. The device of claim 1, further comprising at least one of:
a flexible continuous tension member coupled to the body;
a chain coupled to the body; and
a bead chain coupled to the body.

8. The device of claim 1, wherein the body comprises at least one of a rear cap arranged on the rear end and a front section arranged on the front end.

9. The device of claim 1, wherein the body has a rear cap, a front section, and a main body arranged between the rear cap and the front section.

10. The device of claim 1, wherein the body further comprises a rear cap member which includes a plurality of through openings, a front section member, and a main body member, and wherein at least the front section member is removably connected to the main body member.

11. The device of claim 1, wherein the body comprises a rear cap member which includes a plurality of through openings, a front section member, and a main body member, and wherein each of the rear cap member and the front section member are removably connected to the main body member.

12. A method of making sound with the sound making device of claim 1, the method comprising:
placing the body adjacent a user's lips; and
blowing air through the at least one opening.

13. A method of making the sound making device of claim 1, the method comprising:
forming a main body portion of the body;
coupling the membrane material to the body so that a rim portion of the membrane material is fixed within the body and so that a main portion of the membrane material is stretched; and
connecting a rear cap portion to the main body portion.

14. A sound making device comprising:
a main body comprising a front end, a rear end, an outer side wall arranged between the front and rear ends, and an inner side wall arranged within the outer side wall;
at least one through opening arranged to allow air to enter into the main body;
a membrane member coupled to the body and comprising a rim portion and a main portion;
the rim portion of the membrane member being fixed and the main portion of the membrane member being at least one of stretched, subjected to tension, and assuming a generally planar configuration;
a rear cap coupled to the rear end of the main body and comprising a plurality of through openings;
a first chamber being defined by the outer side wall, the inner side wall and an outer portion of the main portion of the membrane member; and
a second chamber being defined by the inner side wall and an inner portion of the main portion of the membrane member,
wherein the sound making device produces a sound when a user blows air through the at least one opening and the air moves from the first chamber to the second chamber and then out of the front end.

15. The device of claim 14, at least one of:
the outer side wall being at least one of a tapered wall and a conical wall; and
the front end of the main body comprising a smaller diameter than a diameter of the rear end.

16. The device of claim 14, wherein an inner surface of a rim of the rear cap frictionally engages the rim portion of the membrane member and wherein the at least one through opening is arranged on the outer side wall.

17. The device of claim 14, further comprising a front section removably connected to the front end of the main body.

18. A method of making sound with the sound making device of claim 14, the method comprising:
placing the main body adjacent a user's lips; and
blowing air through the at least one opening.

19. A method of making the sound making device of claim 14, the method comprising:
connecting the membrane member to the main body; and
connecting the rear cap to the rear end of the main body so that the rim portion of the membrane member is trapped between an outer surface of the main body and an inner surface of the rear cap.

20. An air horn comprising:
a main body comprising a front end, a rear end, an outer generally conical side wall arranged between the front and rear ends, and an inner side wall arranged within the outer generally conical side wall;
at least one through opening arranged on the outer generally conical side wall;
a generally circular membrane member coupled to the main body and comprising a rim portion and a main portion;
the rim portion of the generally circular membrane member being fixed and the main portion being at least one of stretched, subjected to tension, and assuming a generally planar configuration;
a rear cap coupled to the rear end of the main body and comprising a plurality of through openings;
a front section comprising a rear end coupled to the front end of the main body and an open front end;
a first chamber being defined by the generally conical outer side wall, the inner side wall and an outer portion of the main portion of the membrane member; and
a second chamber being defined by the inner side wall and an inner portion of the main portion of the membrane member,
wherein the horn produces a sound when a user blows air into the at least one opening and the air moves from the first chamber to the second chamber and then out of the open front end of the front section.
